(19) United States
(12) Patent Application Publication
(10) Pub. No.: US 2012/0244869 A1
(43) Pub. Date: Sep. 27, 2012

(54) NETWORK SCALING FOR NETWORK ENERGY SAVINGS

(75) Inventors: Bongyong Song, San Diego, CA (US); Christophe Chevallier, San Diego, CA (US); Soumya Das, San Diego, CA (US); Fabio Akashi, San Diego, CA (US); Xiang Li, San Diego, CA (US); Samir S. Soliman, San Diego, CA (US)

(73) Assignee: QUALCOMM Incorporated, San Diego, CA (US)

(21) Appl. No.: 13/224,156

(22) Filed: Sep. 1, 2011

Related U.S. Application Data
(60) Provisional application No. 61/454,938, filed on Mar. 21, 2011.

(51) Int. Cl. H04W 52/02; H04W 16/32

(52) U.S. Cl. 455/449

(57) ABSTRACT

Methods, systems, devices, and computer program products are described for network scaling. In one example, candidate cells may be selected and ranked. For an initial assessment, the selected cells may operate at a significantly reduced power, and the network performance may be evaluated. Based on the results, only a subset of the candidate cells may be switched off. The whole process may be repeated until all the candidate cells are evaluated. Network downscaling may be done at a site level, a sector level, or a hybrid (site level first, and then additional downscaling by sector level).

### CROSS REFERENCES

The present Application for Patent claims the priority benefit of U.S. Patent Application No. 61/454,938, filed Mar. 21, 2011, having Attorney Docket No. 110948P1, assigned to the assignee hereof, the entirety of which is expressly incorporated by reference herein.

### BACKGROUND

Green initiatives are being pursued by the European Telecommunications Standards Institute (ETSI), 3rd Generation Partnership Project (3GPP), 3GPP2, the Telecommunication Standardization Sector (ITU-T), and other like organizations to reduce CO₂ emissions by wireless networks. As these networks are typically deployed to meet the high traffic demand during peak hours, a scaled down version of the network may be able to effectively handle the lower traffic load in the off-peak hours without substantially compromising the network performance.

Energy saving cell selection may be evaluated by thorough simulations. However, in many proposals, there is high computational complexity in performance simulations. In some cases, the proposals are time consuming and inefficient. There may be a need in the art to provide novel functionality for aspects of the selection of cells for network scaling.

### SUMMARY

The described features generally relate to one or more systems, methods, devices, and computer program products for network scaling. Further scope of the applicability will become apparent from the following detailed description, claims, and drawings. The detailed description and specific examples are given by way of illustration only, since various changes and modifications within the spirit and scope of the description will become apparent to those skilled in the art.

In one example, novel functionality is described for network scaling. Candidate cells (e.g., sites or sectors) may be selected, and the candidate cells may be ranked (e.g., in an automated manner). A selection scheme may incorporate traffic load, cell size, mobile device transmit power, estimated power savings, downlink power consumption, uplink coverage, downlink coverage, call/connection quality, and other factors. For an initial assessment, the selected cells may operate at a reduced power, and the network performance may be evaluated. Based on the results, only a subset of the candidate cells may be switched off. Network scaling may be done at a site level, a sector level, or a hybrid (site level first and then additional scaling down by sector level).

In one example, novel functionality is described for network scaling. Candidate cells (e.g., sites or sectors) may be selected, and the candidate cells may be ranked (e.g., in an automated manner). A selection scheme may incorporate traffic load, cell size, mobile device transmit power, estimated power savings, downlink power consumption, uplink coverage, downlink coverage, call/connection quality, and other factors. For an initial assessment, the selected cells may operate at a reduced power, and the network performance may be evaluated. Based on the results, only a subset of the candidate cells may be switched off. Network scaling may be done at a site level, a sector level, or a hybrid (site level first and then additional scaling down by sector level).

In one example, a network energy savings method may include: identifying a set of candidate cells to power down from a plurality of cells comprising a wireless communications network; ranking the set of candidate cells; and powering down a subset of the set of candidate cells according to the rankings Further, the method may include using a performance threshold to identify the set of candidate cells. The method may include using performance statistics to rank the set of candidate cells. The method may include using performance statistics to rank the set of candidate cells based on traffic load. The method may include using performance statistics to rank the set of candidate cells based on cell size. The method may include using performance statistics to rank the set of candidate cells based on a measurement of transmit power from mobile devices served by each respective cell. The method may include using performance statistics to rank the set of candidate cells based on an estimated power savings from powering down each respective cell. The method may include using performance statistics to rank the set of candidate cells based on a downlink power consumption of each respective cell. The method may include using performance statistics to rank the set of candidate cells based on uplink coverage, downlink coverage, call quality, or connection quality.

In powering down a subset of the candidate cells, the method may include operating at a reduced power to evaluate network performance. Further, the method may include powering off selected candidate cells based on the evaluated network performance during the reduced power operation. In powering down a subset of the candidate cells, the method may include turning off cells; turning off a radio frequency portion or a part of radio frequency portion of respective cells; and/or turning off a baseband portion or a part of baseband portion of the respective cells. In this method, a plurality of cells may include a different sector, a different site, or both sectors and sites.

In another example, a network energy savings system, in powering down a subset of the candidate cells, may include a means for turning off cells, or a means for turning off a radio frequency portion, a part of a radio frequency portion, a baseband portion, or a part of a baseband portion of the respective cells.

In another example, a computer program product may include a non-transitory computer-readable medium comprising: code for identifying a set of candidate cells to power down from a plurality of cells comprising a wireless communications network; code for ranking the set of candidate cells; and code for powering down a subset of the set of candidate cells according to the rankings

A network energy savings system may include: means for identifying a set of candidate cells to power down from a plurality of cells comprising a wireless communications network; means for ranking the set of candidate cells; and means for powering down a subset of the set of candidate cells according to the rankings The system may further include means for using a performance threshold to identify the set of candidate cells. The system may include means for using performance statistics to rank the set of candidate cells. The system may include means for using performance statistics to rank the set of candidate cells based on traffic load. The system may include means for using performance statistics to rank the set of candidate cells based on cell size. The system may include means for using performance statistics to rank the set of candidate cells based on a measurement of transmit power from mobile devices served by each respective cell. The system may include means for using performance statistics to rank the set of candidate cells based on an estimated power savings from powering down each respective cell. The system may include means for using performance statistics to rank the set of candidate cells based on a downlink power consumption of each respective cell. The system may include means for using performance statistics to rank the set of candidate cells based on uplink coverage, downlink coverage, call quality, or connection quality.

In addition, in powering down a subset of the candidate cells, the system may include means for operating at a reduced power to evaluate network performance, and/or means for powering off selected candidate cells based on the evaluated network performance during the reduced power operation. In this system, a plurality of cells may include a different sector, a different site, or both sectors and sites.

In another example, a network energy saving computer system may include: a receiver module configured to receive performance information from a plurality of cells comprising a wireless communications network; a ranking module, in communication with the receiver module, and configured to: identify a set of candidate cells to power down from the plurality of cells; and rank the set of candidate cells; a control module, in communication with the ranking module, and configured to identify a plurality of candidate cells to power down; and a transmitter module, in communication with the control module, and configured to transmit the identification of the plurality of candidate cells to power down. The computer system may include a processor.

In another example, a network energy saving method may include: identifying a plurality of candidate cells to power down; ranking the candidate cells; powering down a subset of the candidate cells according to the rankings; identifying a plurality of candidate sectors to power down; ranking the candidate sectors; and powering down a subset of the candidate sectors according to the rankings

In yet another example, a system may include: means for identifying a plurality of candidate cells to power down; means for ranking the candidate cells; means for powering down a subset of the candidate cells according to the rankings; means for identifying a plurality of candidate sectors to power down; means for ranking the candidate sectors; and means for powering down a subset of the candidate sectors according to the rankings

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of a wireless communication system;

FIG. 2 is a graph illustrating carrier scaling down;

FIG. 3 is a graph illustrating site scaling down;

FIG. 4 is a graph illustrating carrier-site joint scaling down;

FIG. 5 a graph illustrating partial carrier-site joint scaling down;

FIG. 6 is a graph illustrating orthogonal site/sector joint scaling down;

FIG. 7 is a graph illustrating an example of network energy savings;

FIG. 8 is a graph illustrating an alternative example of network energy savings;

FIG. 9 is a block diagram illustrating an example of a central computer system;

FIG. 10 is a block diagram illustrating an example of a ranking module and control module;

FIG. 11 is a flow chart illustrating network scaling;

FIG. 12 is a flow chart illustrating network evaluation and scaling;

FIG. 13 is a flow chart illustrating an alternative example of network evaluation and scaling; and

FIG. 14 is a flow chart illustrating a hybrid site and sector scaling procedure.

### DETAILED DESCRIPTION

The following description generally relates to network scaling. Cells (e.g., sites or sectors) that may be candidates for scaling down may be selected and ranked in an automated manner. A threshold based selection scheme may use performance statistics to select candidate cells. The selected candidate cells are ranked by scores based on performance statistics. For an initial assessment, the cells may operate at a reduced power. Based on the results, only a subset of the candidate cells may be switched off for a final performance evaluation and decision. Network scaling may be done at a site level, a sector level, or a hybrid (site level first and then additional scaling down by sector level).

The following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

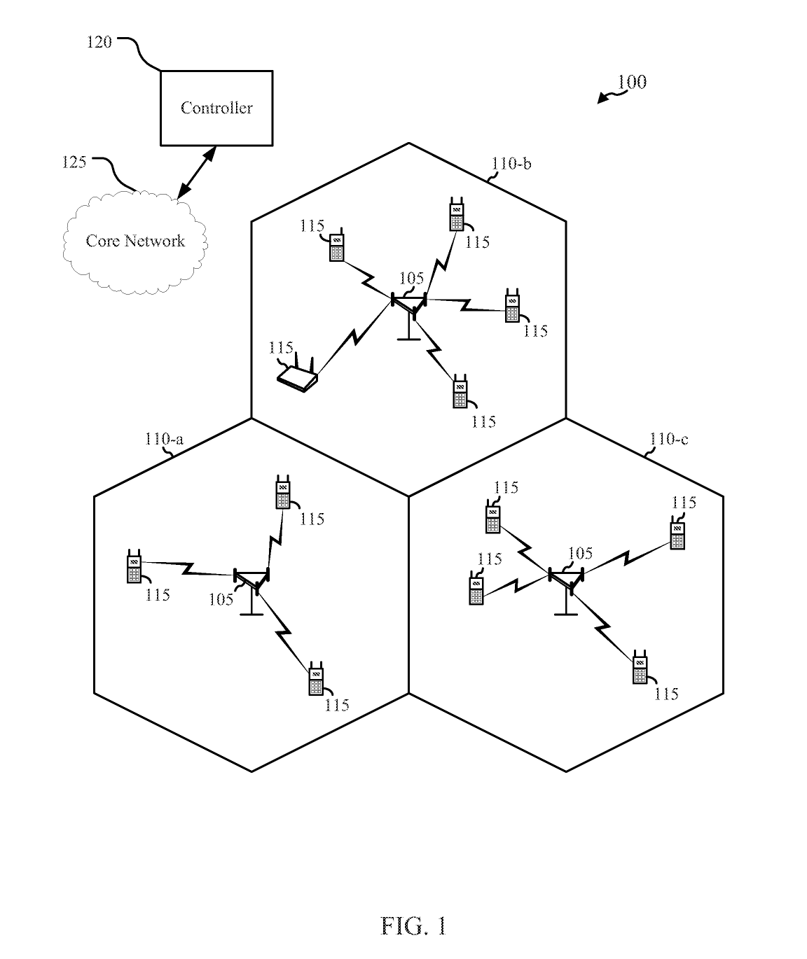

Referring first to FIG. 1, a block diagram illustrates an example of a wireless communications system 100. The system 100 includes base stations 105, mobile devices 115, and a base station controller 120, and a core network 125 (the controller 120 may be integrated into the core network 125). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, Time Division Multiple Access (TDMA) signal, Frequency Division Multiple Access (FDMA) signal, Orthogonal FDMA (OFDMA) signal, Single-Carrier FDMA (SC-FDMA) signal, etc. Each modulated signal may be sent on a different carrier and may carry control information (e.g., pilot signals), overhead information, data, etc. The system 100 may be a multi-carrier LTE network capable of efficiently allocating network resources.

The base stations 105 may wirelessly communicate with the mobile devices 115 via a base station antenna. The base stations 105 are configured to communicate with the mobile devices 115 under the control of the controller 120 via multiple carriers. Each of the base station 105 sites can provide communication coverage for a respective geographic area. The coverage area for each base station here is identified as 110-a, 110-b, or 110-c. The coverage area for a base station may be divided into sectors (not shown, but making up only a portion of the coverage area). The system 100 may include base stations 105 of different types (e.g., macro, micro, and/or pico base stations). As used herein, the term “cell” may refer to 1) a sector, or 2) a site (e.g., a base station 105 site). Collectively, a group of cells may be 1) a group of sectors, 2) a group of sites, or 3) a combination of sectors and sites.

The mobile devices 115 may be dispersed throughout the coverage areas 110. The mobile devices 115 may be referred to as mobile stations, mobile devices, access terminals (ATs), user equipments (UEs) or subscriber units. The mobile devices 115 may include cellular phones and wireless communications devices, but may also include personal digital assistants (PDAs), other handheld devices, netbooks, notebook computers, etc.

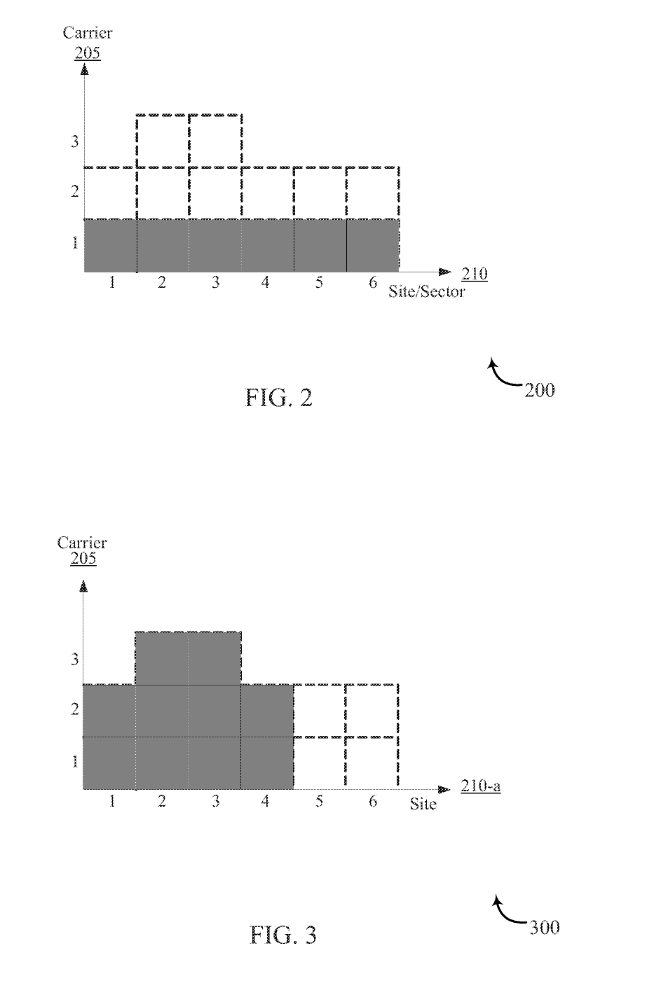

As noted, networks are typically deployed to meet the high traffic demand during peak hours. Therefore, a downscaled version of the network may be able to effectively handle the lower traffic load in the off-peak hours without substantially compromising the network performance. The controller 120 may measure and receive performance statistics from base stations 105 and mobile devices 115 (via base stations 105). The controller 120 may identify candidate cells to be powered down. The controller 120 may rank the candidate cells 110. The controller 120 may power down cells according to the rankings (e.g., powered off or operating a reduced power state). In one example, the controller 120 may evaluate network performance at the reduced power level, and determine the cells to be turned off. A number of network energy savings (NES) techniques will be described in FIGS. 2-6, and such techniques may be used by the controller 120 in the power down process.

Different network scaling down modes may be considered depending on the network types and service goals. There are various ways of utilizing the channel and spatial resources in the network. Consider a wireless network that has multiple carriers over different sites. Different carriers may be used for a single radio access technology (RAT) or multiple radio access technologies (multi-RAT) (e.g., N1 UMTS carriers as the overlay RAT and N2 GSM carriers as the underlay RAT). Different modalities of scaling down the carrier and site dimensions may be defined. The graphs in FIGS. 2-6 illustrate various scaling down principles that may be used by a controller 120 in a network scaling down process. Each y-axis 205 illustrates different carriers, and each x-axis 210 illustrates different sites, or different sectors. The shaded squares indicate whether a particular carrier is turned on for a given site or sector.

Carrier Scaling down: As shown by the graph 200 of FIG. 2, a subset of carriers may be switched off from each site/sector during the NES operation. Traffic load from the switched off carriers are absorbed by the remaining carriers. As at least one entire carrier remains in operation for each site/sector, the network coverage performance is not affected during the NES operation. It may be desirable to maintain the carrier(s) having more favorable propagation characteristics. For example, in a case of one carrier in the PCS band and another carrier in the cellular band, it may be desirable to switch off the PCS band carrier due to better signal coverage offered by the cellular band.

Site Scaling down: As shown by the graph 300 of FIG. 3, a subset of sites 210-a may be switched off during the NES operation. All carriers and sectors of a switched off site are turned off. Traffic load from the switched off sites are absorbed by the surrounding sectors. In some cases, sites may be classified into coverage sites and capacity sites. Coverage sites may ensure the basic signal coverage in the planned service area, and capacity sites may be needed to handle traffic hot spots. It may be desirable to switch off capacity sites in the absence of high traffic demand during the off-peak hours.

Sector Scaling down (not shown): This is similar to site scaling down, but different on/off decisions can be made to different sectors of a site. More flexibility in making a switch off decision can allow higher degree of energy savings in some cases.

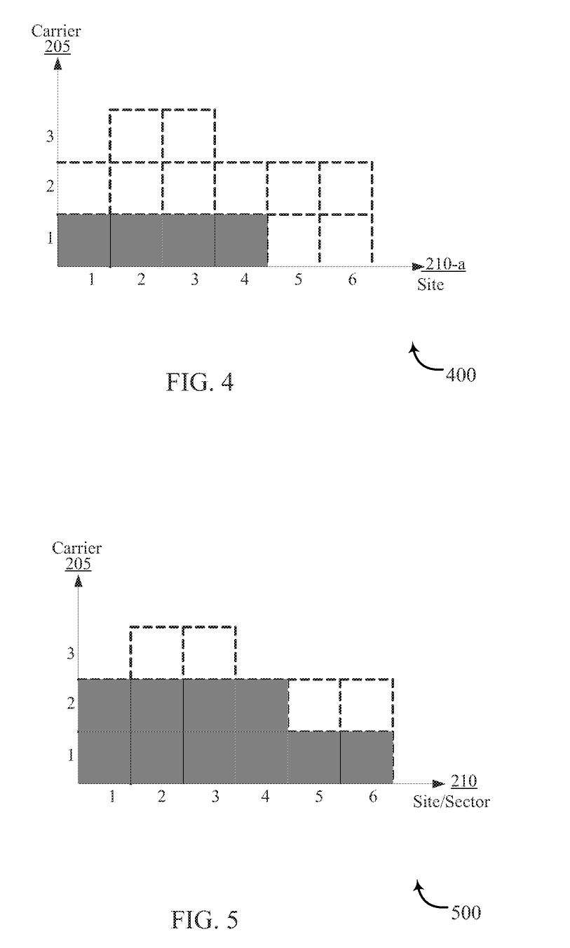

Carrier-Site Joint Scaling down: As shown by the graph 400 of FIG. 4, site scaling down may be used in conjunction with carrier scaling down.

Partial Carrier-Site Joint Scaling down: As shown by the graph 500 of FIG. 5, while conducting carrier-site joint scaling down, at least one carrier is left without any site/sector scaling down. This may be useful in multi-RAT scenarios. By maintaining a complete coverage in the underlay RAT, mobile devices in the coverage holes of the overlay RAT can fall back to the underlay RAT which maintains the global coverage all the time.

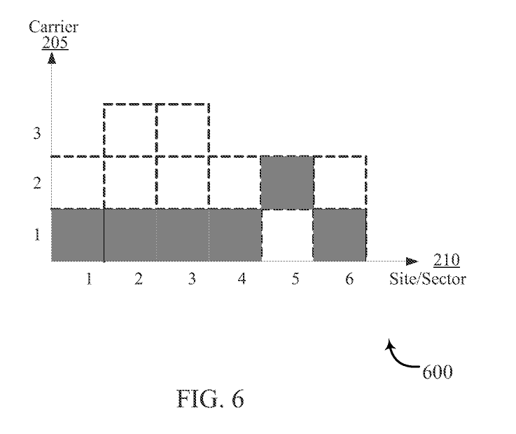

Orthogonal Site/Sector Scaling down: As shown by the graph 600 of FIG. 6, orthogonal site scaling down is conducted between different carriers. Mobile devices in the coverage holes in one carrier can be served by other carriers having an orthogonal set of energy saving sites/sectors.

A higher NES gain may be expected in an urban morphology, as a dense deployment (in both number of carriers and number of sites) offers an opportunity for network energy savings in the presence of low traffic load. Therefore, a more aggressive mode may be considered for urban areas. On the other hand, a relatively sparse deployment in rural areas may allow only some conservative approaches. Therefore, operators may be expected to apply different network scaling down modes to different markets/areas.

Many next generation networks have a multi-RAT configuration. In this case, a few different network scaling options may be considered:

### EXAMPLE 1

Substantially identical scaling down applied to both overlay RAT and underlay RAT: This assumes base stations of two RATs are co-located and offer comparable coverage.

### EXAMPLE 2

Scaling down with complementary coverage: Orthogonal site/sector scaling down may enable RATs to complement each other. Even in the case where a user loses a connection with one RAT, the user may be able to establish a connection with the other RAT.

### EXAMPLE 3

Aggressive overlay scaling down and conservative underlay scaling down: The operator may consider an aggressive scaling down criteria (i.e., relaxed C1), C2), and C3) requirements, as described in more detail below) for the overlay RAT and a more conservative criteria for the underlay RAT. This way each user may be able to get service at least from the underlay RAT.

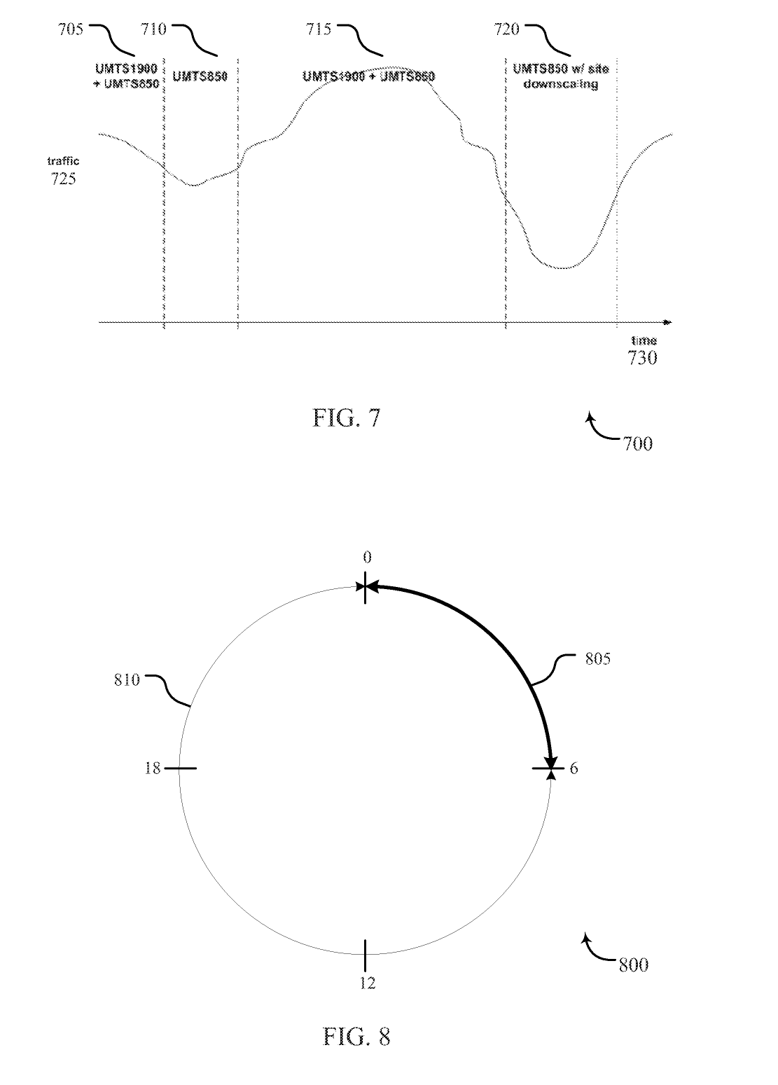

The graph 700 of FIG. 7 illustrates how some of the techniques described above may be used over time. The x-axis 730 illustrates the passage of time over a day, while the y-axis 725 illustrates the amount of traffic. Initially, the traffic is somewhat high during time period 705, so the multi-RAT environment is maintained. One of the RATs is turned off during time period 710, as traffic subsides. As the data traffic picks back up, the multi-RAT environment is re-initiated at time period 715. As traffic again subsides, one of the RATs is turned off during time period 720, and there is site scaling down on the remaining RAT.

The graph 800 of FIG. 8, illustrates how carrier scaling down may be rotated daily in a multi-RAT environment. From midnight to 6:00 a.m. 805, where the traffic load is usually very low, carrier scaling down is used on RAT2 in addition to any scaling down mode on RAT1. From 6:00 a.m. to midnight 810, where more protections for user experience are desired, only carrier scaling down is used on RAT1 without any scaling on RAT2.

It may be desirable to avoid noticeable user experience degradations during the NES operation. Therefore, a set of key performance indicators may be used as standards to be maintained at certain times. For example, the following key performance indicators (KPIs) may be used, individually or collectively:
C1) Received Signal Code Power (RSCP)>−115 dBm in at least 98% of the analysis area;
C2) Ec/No>−16 dB in at least 98% of the analysis area; and
C3) Both circuit switched (CS) and packet switched (PS) call setup success rates stay above a set limit.
   Additional or different criteria may also be used to define the standards in other examples, and identify candidate cells to be powered down. During the designated NES time window, users may be expected to stay indoors. For this reason, it may be desirable that the above standards be satisfied for indoor coverage. Once cell scaling down is enabled, the base station configurations may be optimized for the scaled down network. These include parameter tuning, such as transmit power, signaling radio bearer (SRB) rate, etc., and antenna optimizations (e.g., up/down tilting).

For any given time window, assume base station i consumes P_{BS0,i} during the normal operation and P_{BS1,i} during the energy savings operation. Let B denote the set of all sites in the planned energy saving area. Site scaling down may involve solving a combinatorial optimization problem given by:

$${min}_{S ⋐ B} {\sum }_{i ∉ S} {P}_{BS 0 , i} + {\sum }_{i ∈ S} {P}_{BS 1 , i} s . t . C 1 ) , C 2 ) , C 3 )$$

Aspects of the site selection and ranking approach described herein may be used to conduct the optimization with manageable complexity. This approach may be combined with other methods. For example, one may set an initial set of energy saving sites for a given set of network performance requirements, and then identify additional energy saving sites by ranking the residual sites.

In one example, candidate cells (e.g., sites and/or sectors) may be selected and ranked in an automated manner. A threshold based selection algorithm may be used for selecting candidate cells. Cells that satisfy the criteria are ranked by scores from performance statistics, which may include traffic load, cell size, mobile device transmit power (e.g., aggregated or average), estimated power savings, downlink power consumption, uplink coverage, downlink coverage, call/connection quality, or other factors. Multiple selected cells may be evaluated simultaneously. For an initial assessment, the selected cells may operate at a reduced power, and the network performance may be evaluated. Based on the results, only a subset of the candidate sectors may be switched off for a final performance evaluation and decision. Network scaling down may be done at a site level, a sector level, or a hybrid (site level first and then additional scaling down by sector level). There are a number of alternative implementation options.

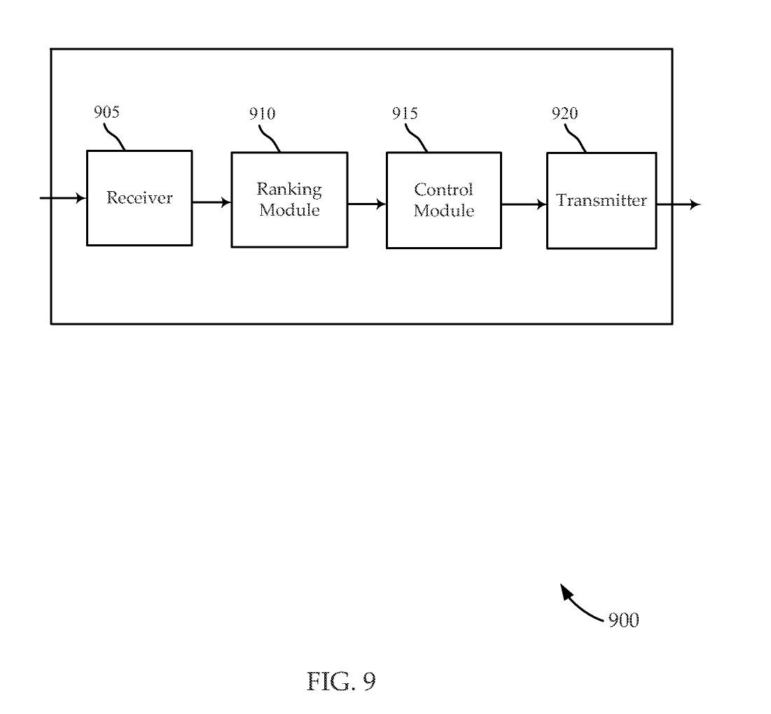

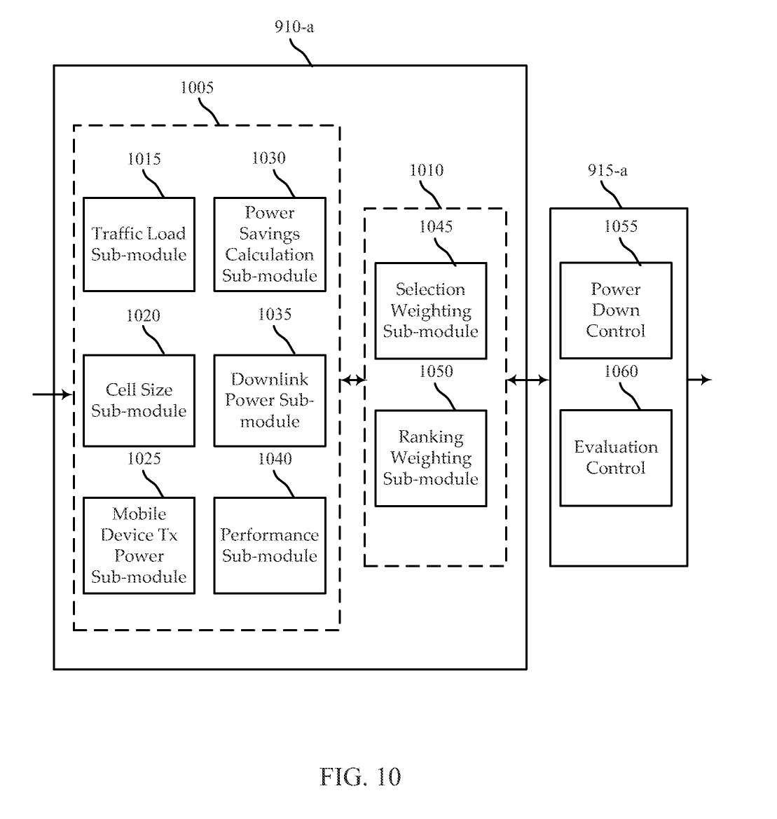

Turning next to FIG. 9, a simplified block diagram shows an example of a central computer system 900. The central computer system 900 may be the controller 120 of FIG. 1. The central computer system 900 may be made up of one or more server computers, workstations, web servers, or other suitable computing devices. The central computer system 900 may be integrated with a base station 105 of FIG. 1, the controller 120 of FIG. 1, the core network 125 of FIG. 1, or a combination thereof. The controller 120 may be fully located within a single facility or distributed geographically, in which case a network may be used to integrate different components. Although the illustrated embodiment shows that a central computer system 900 performs the power down control, in other examples these functions may be performed by other devices or sets of devices.

The central computer system 900 includes a receiver 905, ranking module 910, control module 915, and transmitter 920. The components of the central computer system 900 may, individually or collectively, be implemented, in whole or in part, with instructions embodied in a memory, formatted to be executed by one or more general or application-specific processors. They may also be implemented with one or more Application Specific Integrated Circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art.

The central computer system 900 may control the network powering down for a pre-defined and static number of base stations. The receiver 905 may receive measurement information about each of a number of base stations either directly from the base stations (e.g., the base station 105) or from the associated controllers (e.g., the controller 120). This measurement information may be the signal measurement information collected by a serving cell from the mobile devices it serves. For example, the measurement information may be a reporting set for each cell in an observed set of cells having a signal strength that exceeds a predetermined threshold value.

The ranking module 910 may identify a set of candidate cells to power down from the cells making up a wireless communications network. The ranking module 910 may use performance thresholds to identify the set of candidate cells. The ranking module 910 may rank the set of candidate cells. The ranking module 910 may use performance statistics to rank the set of candidate cells, such as traffic load, cell size, transmit power (e.g., aggregated or average) from mobile devices served by each respective cell, estimate power savings from powering down each respective cell, downlink power consumption of each respective cell, or the uplink coverage, downlink coverage, call quality, or connection quality.

The control module 915 may control the power down of a subset of the set of candidate cells according to the rankings By way of example, the control module 915 may control cells operating at a reduced power to evaluate network performance. The control module 915 may power off selected candidate cells based on the evaluated network performance during the reduced power operation. In other examples, the control module 915 may turn off only a selected portion of respective cells to achieve sufficient energy saving gains while maintaining certain functionalities alive, e.g., turn off only the radio frequency portion of respective cells while maintaining the baseband portion of the cells alive. The control module 915 may aggregate the received measurement information for a population of the mobile devices. The transmitter 920 may transmit the identification of candidate cells to power down to respective base stations.

The receiver 905 may include means for receiving measurements from base stations and mobile devices. The ranking module 910 may include means for identifying a set of candidate cells to power down from a plurality of cells comprising a wireless communications network, and means for ranking the set of candidate cells. The ranking module 910 may include means for using performance statistics to rank the set of candidate cells. The control module 915 may include means for powering down a subset of the set of candidate cells according to the rankings The transmitter 920 may include means for transmitting an identification of the cells to power down.

Turning next to FIG. 10, a simplified block diagram 1000 shows an example of a ranking module 910-a and control module 915-a. The ranking module 910-a and control module 915-a may be the ranking module 910 and control module 915 of FIG. 9. The ranking module 910-a includes a performance measurement module 1005 and a weighting module 1010, which are in communication with each other. The performance measurement module 1005 may receive performance statistics for each of the cells, and the weighting module 1010 may use these statistics to select candidate cells to power down, and to rank the candidate cells.

The performance measurement module 1005 may include a traffic load sub-module 1015 which may receive or calculate traffic load statistics on such metrics as the number of mobile devices served by a cell, the percentage of capacity used by a cell, the number of voice calls, the number and volume of packets processed, etc. The performance measurement module 1005 may include a cell size sub-module 1020 which may receive or calculate cell size statistics (e.g., side-to-side distance, over-the-air roundtrip delays, etc.). The performance measurement module 1005 may include a mobile device transmit power sub-module 1025 which may receive or calculate statistics on the aggregated or average transmit power of mobile devices served by a cell. The performance measurement module 1005 may include a power savings calculation sub-module 1030 which may receive or calculate power savings from powering down a cell. The performance measurement module 1005 may include a downlink power sub-module 1035 which may receive or estimate downlink power consumed by a cell. The performance measurement module 1005 may include a performance sub-module 1040 which may receive or calculate a range of other cell performance statics set forth herein.

As noted above, the weighting module 1010 may weight these statistics to select candidate cells to power down, and rank the candidate cells. The weighting module 1010 includes a selection weighting sub-module 1045 and ranking weighting sub-module 1050. The selection weighting sub-module 1045 may use any combination of the performance statistics of the performance measurement module 1005, and establish threshold based performance criteria for cells to be considered for power down. The ranking weighting sub-module 1050 may use a different combination of the performance statistics of the performance measurement module 1005 to rank the desirability and order of cells to be powered down.

The control module 915-a may be in communication with the ranking module 910-a, and includes evaluation control 1060 and power down control 1055. The control module 915-a may control the power down of a subset of the set of candidate cells according to the rankings By way of example, the evaluation control 1060 may control cells to operate at a reduced power to evaluate network performance. The power down control 1055 may power off selected candidate cells based on the evaluated network performance during the reduced power operation. In other examples, the power down control 1055 may turn off only a selected portion of respective cells such as the radio frequency portion.

As referenced above, to determine which sites or sectors will be selected as candidates for being turned off, there may be threshold based criteria used (e.g., by the ranking module 910-a during the NES time window). The following metrics are additional examples that may be used in candidate selection (“th” indicates a threshold):
Not in a black list provided by the operator
Anticipated sector energy saving gain>Esector,th
Anticipated site energy saving gain>Esite,th (for site selection)
90%-tile CS voice erlang in an interval (e.g., 15 min.)<Tcs,th
90%-tile PS traffic volume in an interval (e.g., 15 min.)<Tps,th
Max site-to-site distance to first tier neighbors<Dth
98%-tile mobile transmit power (from periodic measurement reports by all active mobile devices)<Pth
Total number of Events 6A and 6D reports from UEs<Nth
   6A—UE transmit power becomes larger than an absolute threshold.
   6D—UE transmit power reaches its maximum value.
98%-tile RSCP (from periodic measurement reports by all active mobile devices)>Rth
98%-tile Ec/Io (from periodic measurement reports by all active mobile devices)>SIRth
98%-tile sector total transmit power<Ptx,th
Call setup success rate>Sth
Call drop rate<Qth
   The thresholds may vary for different areas, depending on the morphology (e.g., urban vs. suburban), and depending on the availability of an underlay RAT (e.g., GERAN for UMTS), etc. The initial site selection is done by selecting those sites/sectors satisfying all (or a number above a threshold) of the criteria. Percentile numbers may eventually be determined by an operator and may vary from operator to operator.

In order to determine how candidate sites or sectors will be selected, there may be ranking rules used (e.g., by the ranking module 910-a). The following metrics are examples that may be used in candidate site/sector rankings (note also that other candidate metrics may be used here as well):
Ranked by 90%-tile CS voice erlang
Ranked by 90%-tile PS traffic volume
Ranked by max site-to-site distance to first tier neighbors
Ranked by the number of Events 6A and 6D reports
Ranked by 98%-tile mobile transmit power
Ranked by 98%-tile RSCP
Ranked by 98%-tile Echo
Ranked by 98%-tile sector transmit power
Ranked by anticipated energy saving gain
Ranked by call setup success rate
   Individual rankings may be translated to scores, and the overall ranking may be determined by the total score. In one round of cell selection, the selection may be made by going through all cells in the ranked list in an ordered manner (according to the ranks) A given site may be selected for energy savings evaluation if no adjacent sites with higher ranks are selected. Cells not selected in one round may be on another ranked list for the next round of evaluation.

Once an initial selection is made (e.g., based on the rankings), there may be an optional low power evaluation mode (e.g., by the evaluation control 1060). Initial evaluation can be made by operating the candidate cells at low power (e.g., lowest configurable base station power) before switching them off. Low risk evaluation at the cells can quickly resume the normal power operations if needed.

Switching off a cell may affect the adjacent cells, therefore performance monitoring of adjacent sites/sectors may be desirable. Key performance metrics such as CS and PS traffic, call success rate, call drop rate, RSSI, Ec/Io, mobile transmit power, base station transmit power, maximum round trip delay, etc. may be monitored. In order to facilitate this, periodic measurement reports may be enabled for the mobile devices. An operator may use a threshold based acceptance criteria after evaluating all adjacent sectors in the first tier (“th2” indicates a threshold):
Call setup success rate and call drop rate remain smaller than respective desired thresholds.
90%-tile CS voice erlang<Tcs,th2
90%-tile PS traffic volume<Tps,th2
98%-tile mobile transmit power (from periodic measurement reports by all active mobile devices)<Pth2
Total number of Events 6A and 6D reports<Nth2
98%-tile RSCP (from periodic measurement reports by all active mobile devices)>Rth2
98%-tile Ec/Io (from periodic measurement reports by all active mobile devices)>SIRth2
98%-tile sector total transmit power<Ptx,th2
   If consistent performance degradation is monitored in any of the adjacent sectors during the energy savings window, the cell selection may be canceled. In addition, a selection may be canceled if the cell no longer satisfies the basic selection criteria (due to traffic changes, network configuration changes, etc.). Cancelled cells are deleted from the list.

The procedure may be repeated every X (e.g., 3 months). In one alternative, the sites/sectors may be ranked again and the bottom Y% re-evaluated. Each procedure may have a different energy savings window. The energy savings operation of a sector may be disabled by the operator's input (e.g., a one time public event, disaster recovery, etc.).

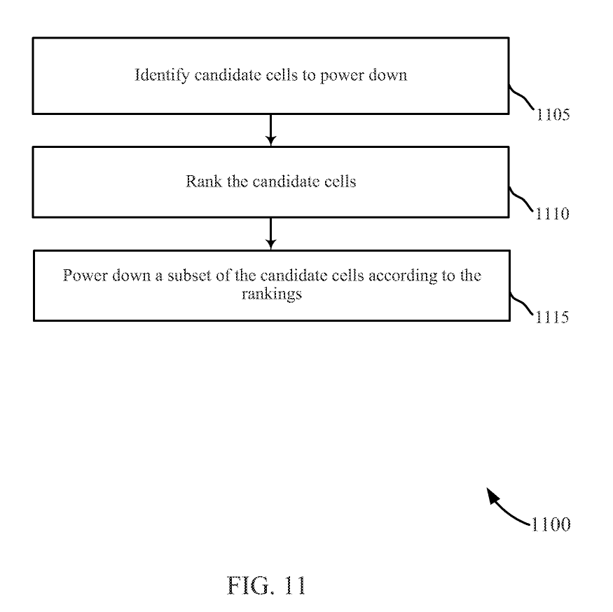

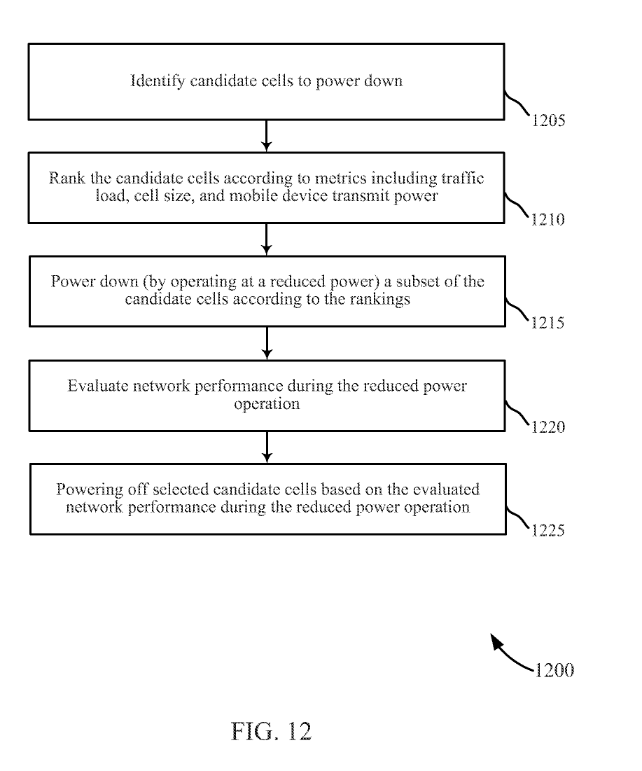

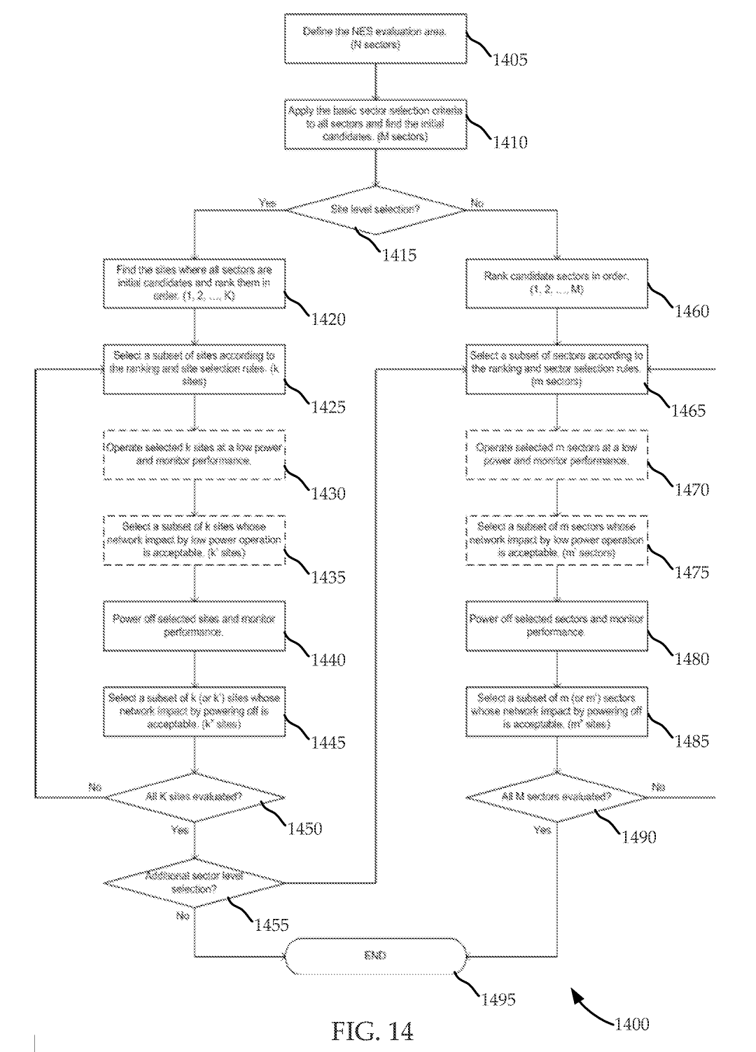

The general procedure described above, may be implemented differently by various operators, and FIGS. 11-14 detail the breadth of such options. The high level option described with reference to FIG. 11 may include any combination of the details described with reference to FIG. 14.

Turning to FIG. 11, a flowchart illustrates a method 1100 of network scaling down. The method 1100 may, for example, be performed by the controller 120, the core network 125, or a base station 105 of FIG. 1, or any combination thereof. The method 1100 may be performed by the computer system 900 of FIG. 9 or, more specifically, the ranking module 910 and control module 915 of FIG. 9 or 10.

At block 1105, candidate cells to power down are identified. At block 1110, the candidate cells are ranked. At block 1115, a subset of the candidate cells is powered down according to the rankings

Turning to FIG. 12, a flowchart illustrates a method 1200 of network evaluation and scaling. The method 1200 may, for example, be performed by the controller 120, the core network 125, or a base station 105 of FIG. 1, or any combination thereof The method 1200 may be performed by the computer system 900 of FIG. 9 or, more specifically, the ranking module 910 and control module 915 of FIG. 9 or 10. The method 1200 may be the method 1100 of FIG. 11.

At block 1205, candidate cells to be powered down are identified. At block 1210, the candidate cells are ranked according to metrics including respective traffic load, cell size, and mobile device transmit power. At block 1215, a subset of the candidate cells are powered down (by operating at a reduced power) according to the rankings At block 1220, network performance is evaluated during the reduced power operation. At block 1225, selected candidate cells are powered off based on the evaluated network performance during the reduced power operation.

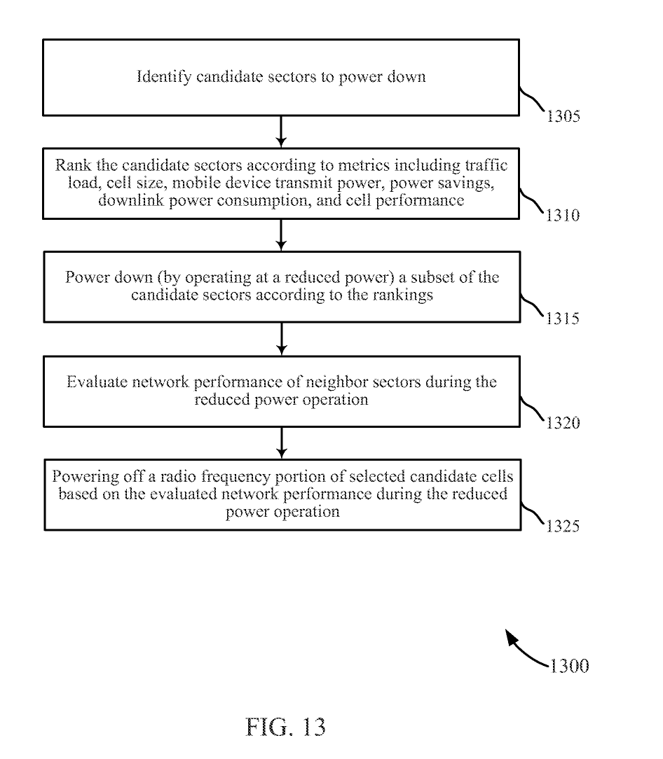

Turning to FIG. 13, a flowchart illustrates an alternative method 1300 of network evaluation and scaling. The method 1300 may, for example, be performed by the controller 120, the core network 125, or a base station 105 of FIG. 1, or any combination thereof. The method 1300 may be performed by the computer system 900 of FIG. 9 or, more specifically, the ranking module 910 and control module 915 of FIG. 9 or 10. The method 1300 may be the method 1100 or 1200 of FIG. 11 or 12.

At block 1305, candidate sectors to be powered down are identified. At block 1310, the candidate sectors are ranked according to metrics including respective traffic load, cell size, mobile device transmit power, power savings, downlink power consumption, and cell performance. At block 1315, a subset of the candidate sectors are powered down (by operating at a reduced power) according to the rankings At block 1320, network performance of neighbor sectors is evaluated during the reduced power operation. At block 1325, a radio frequency portion of selected candidate cells is powered off based on the evaluated network performance during the reduced power operation.

Turning to FIG. 14, a flowchart 1400 illustrates a hybrid site and sector scaling procedure. The method 1400 may, for example, be performed by the controller 120, the core network 125, or a base station 105 of FIG. 1, or any combination thereof. The method 1400 may be performed by the computer system 900 of FIG. 9 or, more specifically, the ranking module 910 and control module 915 of FIG. 9 or 10. The method 1400 may be the method 1100 or 1200 of FIG. 11 or 12.

At block 1405, the NES evaluation area (N sectors) is defined. At block 1410, the basic sector selection criteria is applied to all sectors, and the initial candidates found. At block 1415, a determination may be made whether site level selection will be undertaken. If so, at block 1420, the sites where all sectors are initial candidates are identified and ranked in order (1, 2, . . . K). A low power monitoring scheme may be used. At block 1425, a subset of sites is selected according to the ranking and site selection rules (k sites). At block 1430, k sites are operated at a low power, and performance is monitored. At block 1435, a subset of k sites is selected based on acceptable network impact during low power operation (k′ sites). As shown in FIG. 14, the low power operation and evaluation in blocks 1430 and 1435 is optional. At block 1440, selected sites are powered off, and performance is monitored. At block 1445, a subset of k (or k′ if blocks 1430 and 1435 are exercised) sites based on acceptable network impact by powering off is selected (k″ sites). At block 1450, a determination is made whether all K sites have been evaluated. If not, the method returns to block 1425. If all sites have been evaluated, at block 1455, a determination is made whether to evaluate additional sector level selections. If not, the process ends at block 1495.

If a determination is made at block 1415 that no site level selection will be undertaken, or if a determination is made at block 1455 that there should be additional sector level selections after site selection, the method flows to block 1460. At block 1460, candidate sectors are ranked in order (1, 2, . . . M). At block 1465, a subset of sectors is selected according to the ranking and sector selection rules (m sectors). A low power monitoring scheme may be used. At block 1470, m sectors are operated at low power, and performance is monitored. At block 1475, a subset of m sectors are selected based on acceptable network impact by low power operation (m′ sectors). As shown in FIG. 14, blocks 1470 and 1475 are optional. At block 1480, selected sectors are powered off, and performance is monitored. At block 1485, a subset of m (or m′ if blocks 1470 and 1475 are exercised) sectors are selected for powering off based on acceptable network impact (m″ sectors). At block 1490, a determination is made whether all M sectors have been evaluated. If not, the method returns to block 1465. If all sectors have been evaluated, the process ends at block 1495.

In some instances, it may be worthwhile to conduct network scaling down in a seamless manner. A variety of techniques may be used, alone or in combination, to attempt to provide for seamless network scaling down. Different procedures are desired for carrier scaling down and site/sector scaling down. For carrier scaling down, assume that there is a two-carrier, UMTS system, with UMTS850 and UMTS1900. The following is an example migration of network scaling down of UMTS1900.
Step 1:
   Adjust cell reselection parameters to migrate all idle UEs to UMTS850 and avoid UEs reselecting UMTS 1900.
   Direct retry to UMTS850 or GSM for all new call requests.
   Allow time for most active calls/connections to naturally end (T seconds).
   Wait until all emergency calls end.
Step 2:
   Slow cell wilting. This will naturally trigger inter-frequency or inter-RAT handover for any remaining active UEs.
Step 3:
   Forced inter-frequency or inter-RAT handover for any still remaining active UEs.
   Switch off a cell when no active UEs exist.
Step 4:
   Performance monitoring of traffic absorbing carrier (and conduct emergency restoration as needed).

Regarding the cell reselection parameters in Step 1, a variety of techniques may be used, alone or in combination, to provide for migrating users from one carrier (f1) to another carrier (f2):
Trigger inter-frequency measurements at the UEs in f1:
   Increase Sintersearch in SIB3 of f1 cells to trigger inter-frequency measurements by the idle UEs.
   Do not send Sintersearch in SIB3 of f1 cells to trigger inter-frequency measurements by the Idle UEs.
Enforce f2 cell reselection:
   Influence cell reselection ranking by setting a negative Qoffsets,n for f2 cells in SIB11.
      An f2 neighbor gets the highest ranking
      Similar method can be used for inter-RAT migration.
   Adjust Ssearch,RAT and Cell individual offset.

A variety of techniques may be used, alone or in combination, for switching off a cell in a seamless manner for cell scaling down.
Step 1:
   Allow time for (most) active calls/connections to naturally end (T seconds).
   Wait until all emergency calls end.
Step 2:
   Slow cell wilting. This will naturally trigger intra-frequency, inter-frequency or inter-RAT handover for any remaining active UEs.
Step 3:
   Force intra/inter-frequency or inter-RAT handover for any still remaining active UEs.
   Switch off a cell when no active UEs exist. For fast restoration, only PA (power amplifier) modules (and some subset of base band units) can be turned off in the switched off base stations.
   Update SIBs for UMTS850 (and underlay GERAN cells).
   Add new neighbors (deleting switched off cells is optional).
Step 4:
   Monitor performance of remaining sectors (and conduct emergency restoration as needed).

A variety of techniques may be used, alone or in combination, for cell restoration.
Step 1:
   Switch on the UMTS850 cell.
      Switch on can be delayed while emergency calls are in progress.
      One-by-one restoration (one sector ON at a time) to avoid sudden DL interference increase.
      Simultaneous restoration of distant cells is allowed.
Step 2:
   Restore the original SIB 11/12 for neighbor UTRAN and GERAN cells.
Step 3:
   Start cell blossoming.
      Relatively slow power increase to avoid interference to neighboring UMTS850 cells.
   Allow emergency restoration.
      Cell restoration can start at any time due to sudden traffic increase, performance degradations, etc.

A variety of techniques may be used, alone or in combination, for carrier restoration.
Step 1:
   Switch on all UMTS1900 cells.
      Simultaneous restoration of all cells that do not have currently active intra-frequency neighbors.
Step 2:
   Update SIB Type 11 and 12 for neighbor UTRAN and GERAN cells.
      Need to update the SIBs for UMTS850, too.
Step 3:
   Start cell blossoming.
      Relatively fast power increase if there are no active neighboring UMTS1900 cells.
      Relatively slow power increase if there are active neighboring UMTS1900 cells (boundary cells).
         There may be an emergency restoration, and carrier restoration can start at any time due to sudden traffic increase, performance degradations, etc.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3rd Generation Partnership Project” (3GPP). cdma2000 is described in documents from an organization named “3rd Generation Partnership Project 2” (3GPP2). These various radio technologies and standards are known in the art.

The detailed description set forth above in connection with the appended drawings describes examples and does not represent the only embodiments that may be implemented or that are within the scope of the claims. The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the description is not to be limited to the examples and designs described herein, but is to be accorded the widest scope consistent with the principles and novel features disclosed herein.

1. A method comprising:
identifying a set of candidate cells to power down from a plurality of cells comprising a wireless communications network;
computing a performance statistic score for each of the candidate cells;
ranking the set of candidate cells in an order based on the performance statistic score of each of the candidate cells; and
powering down a subset of the set of candidate cells according to the rankings

2. The method of claim 1, further comprising:
using a performance threshold to identify the set of candidate cells.

3. The method of claim 1, wherein the computing the performance statistic score for each of the candidate cells further comprises:
measuring performance statistics for each of the candidate cells to compute the performance statistic scores for the set of candidate cells.

4. The method of claim 1, further comprising:
using performance statistics to rank the set of candidate cells based on traffic load.

5. The method of claim 1, further comprising:
using performance statistics to rank the set of candidate cells based on cell size.

6. The method of claim 1, further comprising:
using performance statistics to rank the set of candidate cells based on a measurement of transmit power from mobile devices served by each respective cell.

7. The method of claim 1, further comprising:
using performance statistics to rank the set of candidate cells based on an estimated power savings from powering down each respective cell.

8. The method of claim 1, further comprising:
using performance statistics to rank the set of candidate cells based on a downlink power consumption of each respective cell.

9. The method of claim 1, further comprising:
using performance statistics to rank the set of candidate cells based on uplink coverage, downlink coverage, call quality, or connection quality.

10. The method of claim 1, wherein powering down a subset of the candidate cells comprises:
operating at a reduced power to evaluate network performance.

11. The method of claim 10, further comprising:
powering off selected candidate cells based on the evaluated network performance during the reduced power operation.

12. The method of claim 1, wherein powering down a subset of the candidate cells comprises:
turning off cells.

13. The method of claim 1, wherein powering down a subset of the candidate cells comprises:
turning off a radio frequency portion or a part of radio frequency portion of respective cells.

14. The method of claim 1, wherein powering down a subset of the candidate cells comprises:
turning off a baseband portion or a part of baseband portion of the respective cells.

15. The method of claim 1, wherein each of the plurality of cells comprise a different sector.

16. The method of claim 1, wherein each of the plurality of cells comprise a different site.

17. The method of claim 1, wherein the plurality of cells comprise a combination of sectors and sites.

18. A computer program product comprising:
a non-transitory computer-readable medium comprising:
code for identifying a set of candidate cells to power down from a plurality of cells comprising a wireless communications network;
code for computing a performance statistic score for each of the candidate cells.
code for ranking the set of candidate cells in an order based on the performance statistic score of each of the candidate cells; and
code for powering down a subset of the set of candidate cells according to the rankings

19. A system comprising:
means for identifying a set of candidate cells to power down from a plurality of cells comprising a wireless communications network;
means for computing a performance statistic score for each of the candidate cells.
means for ranking the set of candidate cells in an order based on the performance statistic score of each of the candidate cells; and
means for powering down a subset of the set of candidate cells according to the rankings

20. The system of claim 19, further comprising:
means for measuring performance statistics for each of the candidate cells to compute the performance statistic scores for the set of candidate cells.
